(19) United States
(12) Patent Application Publication
(10) Pub. No.: US 2024/0426262 A1
(43) Pub. Date: Dec. 26, 2024

(54) LIQUID-PROPELLANT ENGINE AND METHOD OF USE

(71) Applicant: Heathe W. Ball, Grain Valley, MO (US)

(72) Inventor: Heathe W. Ball, Grain Valley, MO (US)

(21) Appl. No.: 18/212,923

(22) Filed: Jun. 22, 2023

(51) Int. Cl. F02K 9/56; F01D 15/10; F02C 7/12; F02C 9/26; F02K 9/46

(52) U.S. Cl. CPC F02K 9/563; F01D 15/10; F02C 7/12; F02C 9/26; F02K 9/46

(57) ABSTRACT

An improved liquid-propellant engine utilizing a combination of a gas turbine, a generator, an electric pump fed engine, and a power management system. When in use, the gas turbine and generator are configured for providing power to an electric motor for operating a fuel pump and an oxidizer pump to pump fuel and oxidizer from individual tanks into a combustion chamber for mixture and combustion. The combustion of the fuel and oxidizer is configured for providing thrust from the base of a rocket to propel it. The generator of the present invention provides continuous electrical power to the electric pump(s) to continue the supply of fuel and oxidizer to the combustion chamber. The power management system of the present invention is electrically connected to the generator, the electric motor(s) configured for operating the fuel and oxidizer pumps, a flight computer, and fuel and oxidizer valves.

### BACKGROUND OF THE INVENTION

### 1. Field of the Invention

The present invention relates generally to liquid-propellant engines and more specifically, to a liquid-propellant engine having a gas turbine generator and an electric pump and methods of use thereof.

### 2. Description of the Related Art

Liquid-propellant engines are commonly used to propel rockets, functioning by pumping a liquid fuel and a liquid oxidizer into a combustion chamber to create a reaction with a thrust which propels the rocket. Common types of liquid-propellant engines include gas-generator pump engines and electric-pump-fed engines. However, these types of engines have their disadvantages.

Conventional gas turbine geared pumps utilized in rocket engines are quite difficult to control or throttle. In contrast, currently available electrically driven pumps are easier to control or throttle than gas turbine pumps, however such electric pumps require a battery to power the pumps. The power required to operate the fuel and oxidizer pumps of a rocket engine is significant, which requires either large batteries or numerous smaller batteries which are very heavy onboard the rocket. Accordingly, more fuel and oxidizer are required to propel such heavy rockets having electrically driven pumps with large batteries.

What is needed is a liquid-propellant engine which is lighter than current battery-powered electric pump fed engines but has electric powered pumps which are easier to control than a traditional gas turbine engine. Heretofore there has not been available a liquid-propellant engine and method with the advantages and features of the present invention.

### SUMMARY OF THE INVENTION

The present invention covers an improved liquid-propellant engine utilizing a combination of a gas turbine, a generator, an electric pump fed engine, and a power management system. When in use, the gas turbine and generator are configured for providing power to an electric motor for operating a fuel pump and/or an oxidizer pump to pump fuel and oxidizer from individual tanks into a combustion chamber for mixture and combustion. The combustion of the fuel and oxidizer is configured for providing thrust from the base of a rocket to propel it. The generator of the present invention provides continuous electrical power to the electric pump(s) to continue the supply of fuel and oxidizer to the combustion chamber.

The power management system of the present invention is electrically connected to the generator, the electric motor(s) configured for operating the fuel and oxidizer pumps, a flight computer, and fuel and oxidizer valves. In an exemplary embodiment, the power management system is integrated into the flight computer. The power management system is configured for directing and controlling power to and from the gas turbine and generator and to the pump electric motor for continued operation of the engine. In an aspect of the present invention, the power management system includes a processor programmed for automatically managing the power and operation of the engine based on predetermined settings. However, in alternative embodiments, the power management system may be controlled remotely by a user via a remote computing device.

In another aspect of the present invention, the engine further integrates valves controllable by the power management system for directing fuel and oxidizer from the pumps to the combustion chamber and/or the gas generator. The valves are configured for being open and closed as necessary to supply fuel and oxidizer to operate the gas generator and turbine and to the combustion chamber.

In embodiments of the present invention, the system further includes a battery configured to initially power the power management system and the electric motor for the pumps until the generator starts operating. The battery required in this embodiment is much smaller and lighter than the batteries used in standard electric pump fed liquid-propellant engines because it is only needed to initially power the motor. Alternative embodiments do not utilize a battery, and the power management system and pump electric motor are initially powered by other means, such as but not limited to power from an outside electric current until the gas generator is operating.

The present invention reduces the weight associated with electric pump fed engines while still utilizing an electric pump which is easier to control or throttle than traditional gas turbine pumps. In embodiments of the present invention, the electric generator can be driven by a variety of means including gases from a pre-burner, chemical catalyst, and engine cooling, among others, and the generated electricity is then used to power the fuel and oxidizer pump(s).

### BRIEF DESCRIPTION OF THE DRAWINGS

The drawings constitute a part of this specification and include exemplary embodiments of the present invention illustrating various objects and features thereof.

FIG. 1 shows a schematic diagram of a rocket engine embodying the present invention.

FIG. 2 shows a schematic diagram of an alternative rocket engine embodying the present invention.

FIG. 3 shows a schematic drawing of an additional embodiment of a rocket engine of the present invention.

FIG. 4 shows a schematic drawing of an embodiment of a rocket engine of the present invention.

FIG. 5 shows a schematic drawing of a further embodiment of a rocket engine of the present invention.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Additionally, anatomical terms are given their usual meanings. For example, proximal means closer to the trunk of the body, and distal means further from the trunk of the body. Said terminology will include the words specifically mentioned, derivatives thereof and words of similar meaning.

### II. Preferred Embodiment Rocket Engine System 2

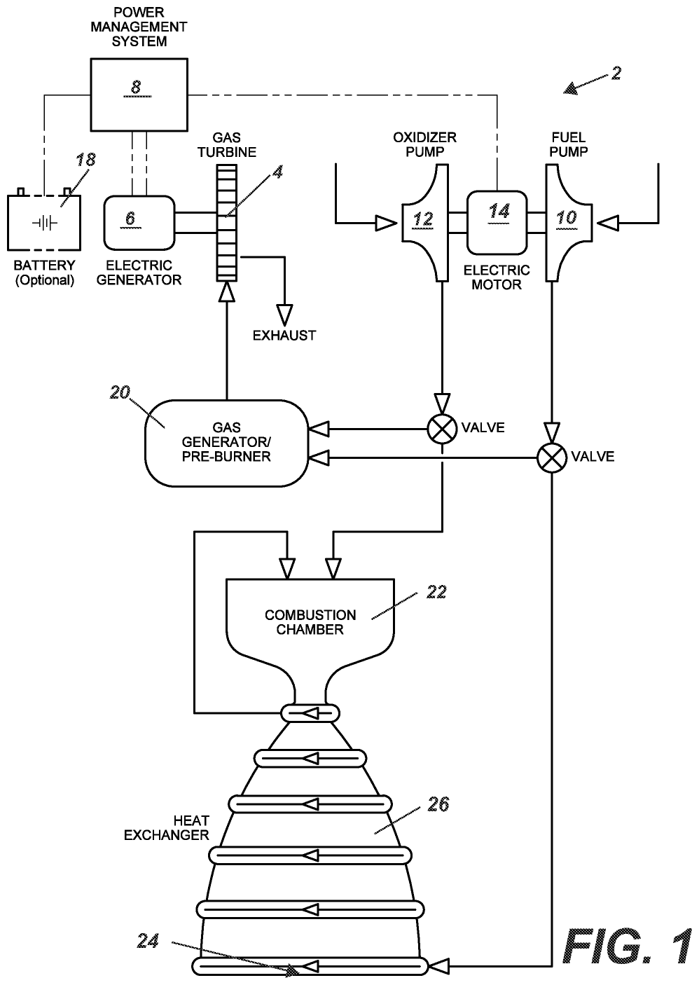

As shown in FIG. 1, the present invention discloses a rocket engine system 2 employing a liquid-propellant engine having a gas turbine, a generator, a power management system, and one or more electrically powered pumps. The combination of a gas turbine 4, generator 6, and electric pump provides an engine which is lighter than battery-powered electric pump fed engines but is easier to control or throttle than a traditional gas turbine engine. When running, the gas turbine 4 and generator 6 are configured for providing continuous electrical power to the electric motor 14. In a preferred embodiment, the electric motor 14 is configured for operating a fuel pump 10 and an oxidizer pump 12 to pump fuel and oxidizer from individual tanks into a combustion chamber 22 for mixture and combustion. The combustion of the fuel and oxidizer is configured for providing thrust from the base of a rocket out the nozzle 26 to propel it. The present invention is adaptable for use with nearly all fuel and oxidizer configurations. Typical components such as a heat exchanger 24 are also employed to increase efficiency.

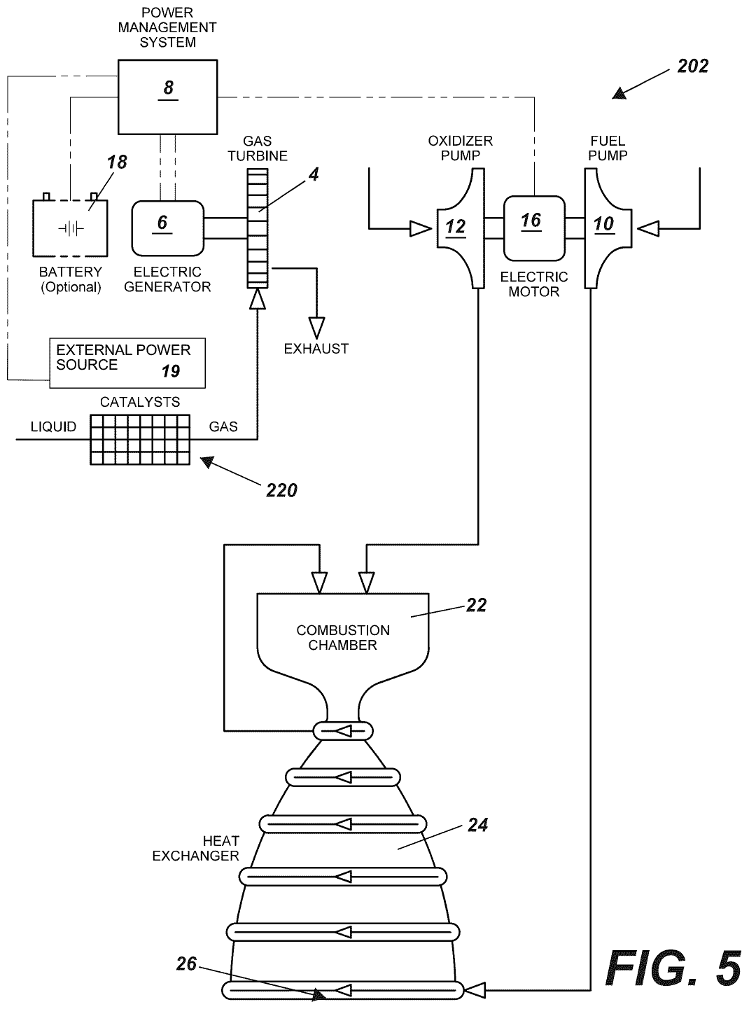

The engine 2 further integrates valves controllable by the power management system 8 for directing fuel and oxidizer from the pumps to the combustion chamber and/or to the gas generator 20. The valves are configured for being open and closed as necessary to supply fuel and oxidizer to operate the gas generator and turbine and to the combustion chamber. In an alternative embodiment engine system 202 as shown in FIG. 5, chemical catalysts 220 may be utilized to power the gas turbine and generator rather than valves supplying fuel and oxidizer to pre-burner gases or valve(s) supplying engine cooling gases.

The power management system 8 of the present invention is electrically connected to the generator 6, the electric motor(s) 14 configured for operating the fuel 10 and oxidizer 12 pumps, a flight computer (not shown) integrated into the vehicle (not shown) powered by the engine 2, and fuel and oxidizer valves. In this embodiment embodiment, the power management system 8 is integrated into the flight computer, but in alternative embodiments, the power management system may be an independent system from the flight computer.

The power management system 8 is configured for directing and controlling power to and from the gas turbine 4 and generator 6 and to the electric motor 14 for continued operation of the engine. In an exemplary embodiment of the present invention, the power management system 8 includes a processor programmed for automatically managing the power and operation of the engine based on predetermined settings. Alternatively, the power management system may be controlled remotely by a user via a remote computing device (not shown) connected to the power management system processor over a communications network, such as a wireless Wi-Fi network or similar known networks (not shown).

The valves are configured for being open and closed as necessary to supply fuel and oxidizer to operate the gas generator and turbine and to the combustion chamber. In an alternative embodiment engine system 202 as shown in FIG. 5, chemical catalysts 220 may be utilized to power the gas turbine and generator rather than valves supplying fuel and oxidizer to pre-burner gases or valve(s) supplying engine cooling gases.

In an exemplary embodiment, the power management system is connected and supplemental to an overall engine control system. Such system includes sensors positioned throughout the engine, including but not limited to fuel flow, combustion chamber pressure, combustion chamber temperature, pump revolutions per minute (RPM), turbine RPM, valve position, electric motor temperature, battery, and generator sensors. In embodiments, the power management system may either control the opening and closure of pump valves directly or indirectly through the overall engine control system.

In embodiments of the present invention, the electric generator can be driven by a variety of means including gases from a pre-burner 20, chemical catalyst 220, and engine cooling, among others, and the generated electricity is then used to power the fuel 10 and oxidizer 12 pump(s). Exhaust from the gas turbine 4 may be dumped overboard as part of a gas generator cycle. Alternatively, exhaust from the gas turbine may be dumped into the main combustion chamber as part of a fuel-rich, oxidizer-rich, or full-flow staged combustion cycle.

In embodiments of the present invention, the system further includes a battery 18 configured to initially power the power management system 8 and the electric motor 14 for the pumps 10, 12 until the generator 6 starts operating to supply power to the motor 14. The battery 18 required in this embodiment is much smaller and lighter than the batteries used in standard electric pump fed liquid-propellant engines because it is only needed to initially power the motor, to run the power management system, to generate a magnetic field in the generator, and/or for energy storage for instant electrical response. Alternative embodiments of the present invention do not utilize a battery at all, and the power management system and pump electric motor are initially powered by other means, such as but not limited to power from an outside electric current until the gas generator is operating.

### III. Alternative Embodiment Rocket Engine System 52

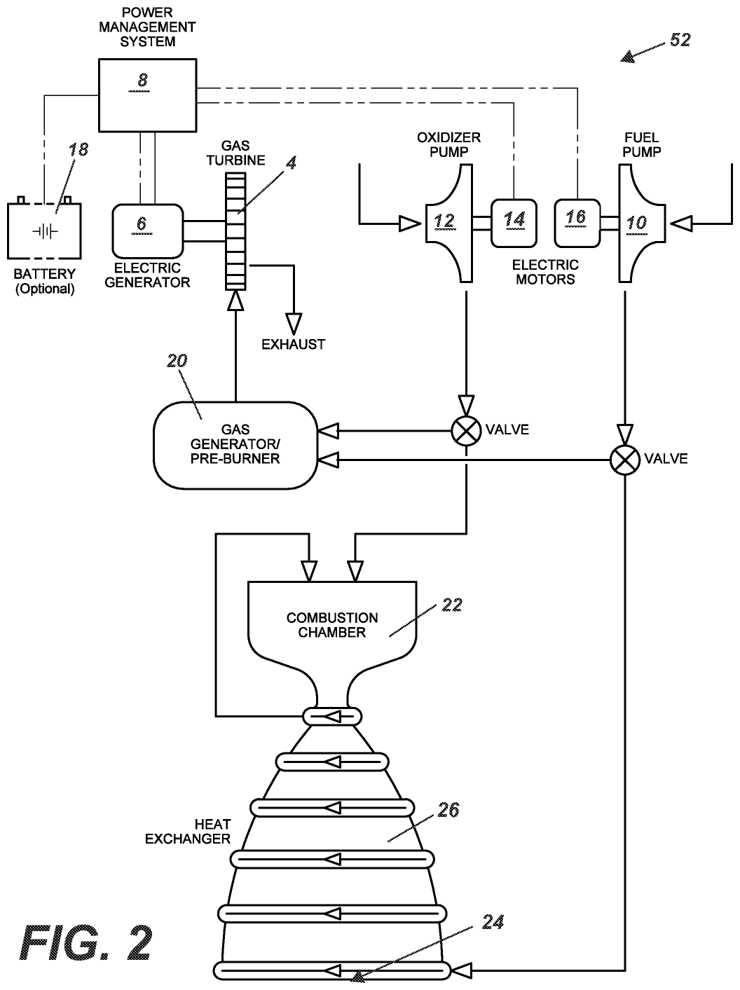

FIG. 2 shows a slightly alternative embodiment rocket engine system 52 wherein a second electric motor 16 is employed to increase output of the fuel 10 and oxidizer 12 pumps.

### IV. Alternative Embodiment Rocket Engine System 102

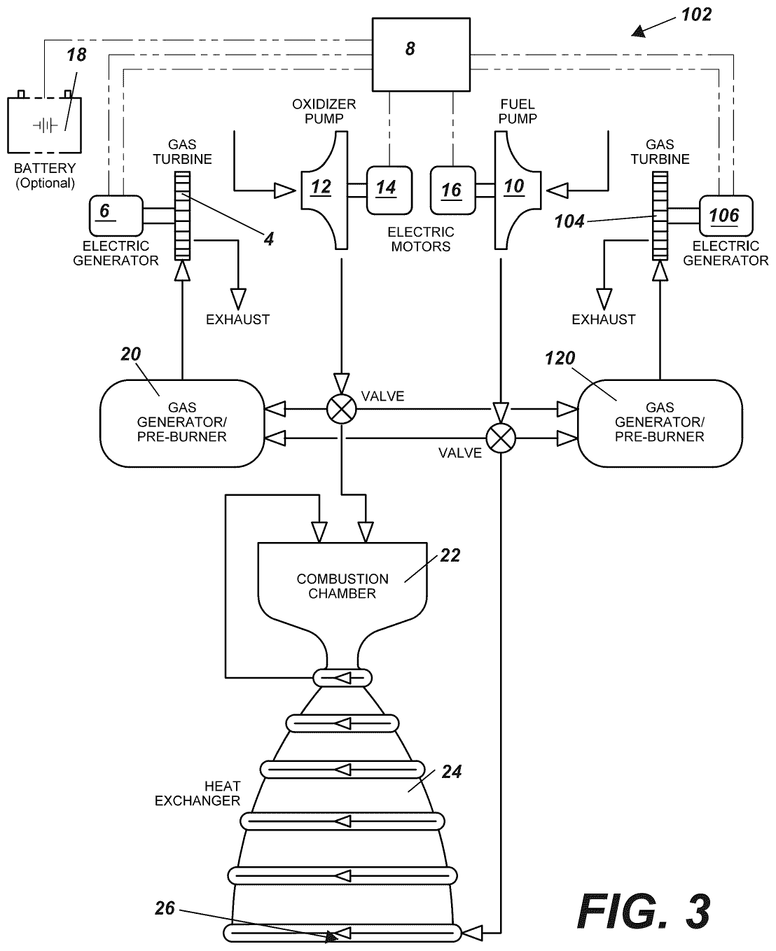

FIG. 3 shows another slightly alternative embodiment rocket engine system 102 wherein a second electric motor 16 is employed to increase output of the fuel 10 and oxidizer 12 pumps. In addition, a second gas turbine 104 and electric generator 106 are employed to increase power output to the electric motors. A second gas generator or pre-burner 120 is shown as well to provide additional power as needed.

### V. Alternative Embodiment Rocket Engine System 152

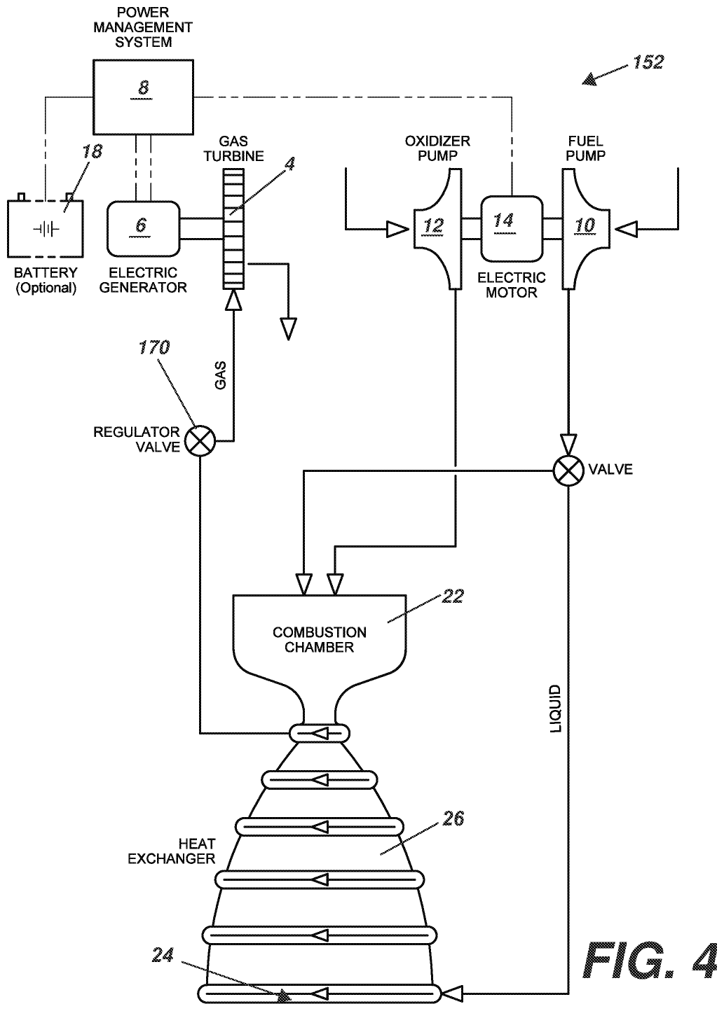

FIG. 4 shows yet another slightly alternative embodiment rocket engine system 152 wherein the gas generator or pre-burner 20 of the previous embodiments is not required. Instead, a regulator valve 170 feeds gas back into the gas turbine from liquid pulled from the cooling system of the rocket engine via the heat exchanger 24 or other cooling system elements.

### VI. Alternative Embodiment Rocket Engine System 202

As discussed previously, FIG. 5 shows a final alternative embodiment rocket engine system 202 wherein the gas generator or pre-burner 20 of the previous embodiments is instead replaced with chemical catalysts 202 which provide power for the gas turbine.

In addition to these embodiments, the present invention can utilize optional methods for generating a magnetic field for the generator. A battery 18 as discussed above may be used. Alternatively, permanent magnets deployed within the system could be used to generate the necessary magnetic field. External power connections can also be used to provide the initial power to the generator 6 for generating the magnetic field, after which the external power can be disconnected.

The power management system 8 can be incorporated into the flight computer as discussed above, or into other control computer systems within the rocket engine system. The control computer would be capable of managing generator output, throttle of the turbine, mixture of the fuel pump and oxidizer pump, as well as monitoring and controlling other systems and subsystems for providing more efficient power through the engine.

These embodiments could be incorporated as part of a hybrid approach. In addition to providing 100% of the energy required to spin the turbopump(s), the system can be added to traditional existing systems for assistance or to assist those additional systems. This would allow for the combination to operate more powerful engines and maintain better throttle control.

A cooling system could be incorporated for the motor and/or the generator. In addition to the heat exchanger 24 and other cooling systems for the engine itself, these cooling systems could further be used to provide efficiency to the system, and the excess heat may be further used to power other elements of the system.

These systems have built-in flexibility for design and construction. The gas generator 20, turbine 4, and turbopump are not required to be on the same shaft. Thus there are no extreme temperature differences within shared housings. The gas generator tends to be extremely hot, but this allows for protection and isolation of unburnt cryogenic fuels.

It is to be understood that while certain embodiments and/or aspects of the invention have been shown and described, the invention is not limited thereto and encompasses various other embodiments and aspects.

1. A rocket engine system comprising:
one or more rocket engines comprising a combustion chamber and a nozzle;
a turbine powering an electric generator via a power source;
an electric motor configured to power an oxidizer pump and a fuel pump;
a power management system electrically and communicatively connected to said electric generator, said electric motor, a computing device, and a plurality of valves;
said computing device comprising a processor, data storage, and user interface;
said power management system configured to direct and control power to and from said turbine, said electric generator, and said electric motor;
said power management system further configured to control output of said oxidizer pump and said fuel pump via said plurality of valves, and said power management system further configured to monitor a temperature of said electric motor and a status of said electric generator; and
said computing device configured to automatically operate said power management system to optimize efficiency of power output by said one or more rocket engines.

2. The rocket engine system of claim 1, wherein said power source comprises a battery, said battery being configured to optionally store energy for an instant electrical response.

3. The rocket engine system of claim 1, wherein said power source comprises a gas generator.

4. The rocket engine system of claim 1, wherein said power source comprises a pre-burner.

5. The rocket engine system of claim 1, wherein said power source comprises a chemical catalyst.

6. The rocket engine system of claim 1, wherein said power source comprises an external electrical power source.

7. The rocket engine system of claim 1, further comprising a second electric motor configured to power said oxidizer pump and said fuel pump.

8. The rocket engine system of claim 7, further comprising a second turbine and a second electric generator.

9. The rocket engine system of claim 1, wherein said one or more rocket engines include a cooling system.

10. The rocket engine system of claim 9, wherein said cooling system comprise a heat exchanger.

11. The rocket engine system of claim 9, further comprising:
a regulator valve connecting said cooling system to said turbine;
said regulator valve configured to provide power to said electrical generator via said turbine.

12. The rocket engine system of claim 1, further comprising:
said at least one rocket engine associated with a vehicle comprising a flight computer; and
wherein said computing device is said flight computer.

13. The rocket engine system of claim 1, wherein said power management system is further comprised to monitor subsystem statuses of the rocket system engine, the subsystem statuses selected from the list comprising: fuel flow, combustion chamber pressure, combustion chamber temperature, pump revolutions per minute (RPM), turbine RPM, valve position, electric motor temperature, battery charge level, and generator fuel flow.
